(19) United States
(12) Patent Application Publication
(10) Pub. No.: US 2015/0264285 A1
(43) Pub. Date: Sep. 17, 2015

(54) IMAGE PROCESSING APPARATUS AND SOLID-STATE IMAGING APPARATUS

(71) Applicant: Kabushiki Kaisha Toshiba, Minato-ku (JP)

(72) Inventor: Yukiyasu TATSUZAWA, Yokohama-shi (JP)

(73) Assignee: Kabushiki Kaisha Toshiba, Minato-ku (JP)

(21) Appl. No.: 14/444,306

(22) Filed: Jul. 28, 2014

(30) Foreign Application Priority Data
Mar. 13, 2014 (JP) 2014-050550

(51) Int. Cl. H04N 5/367; H04N 5/3745; H04N 5/361

(52) U.S. Cl. CPC H04N 5/367; H04N 5/361; H04N 5/37455

(57) ABSTRACT

According to one embodiment, an image processing apparatus includes a defect correcting circuit. The defect correcting circuit includes a defect judging unit, a first correcting unit, and a second correcting unit. The defect judging unit performs defect judgment on a target pixel. The first correcting unit performs replacement of a pixel value of the target pixel detected as a defect based on a result of the defect judgment. The second correcting unit performs an interpolating process of a pixel value on a designated pixel. The designated pixel is the pixel of which positional information is registered in advance as a defect. When the second correcting unit performs the interpolating process, the defect judging unit performs the defect judgment according to the pixel value subjected to the interpolating process.

### CROSS-REFERENCE TO RELATED APPLICATIONS

This application is based upon and claims the benefit of priority from Japanese Patent Application No. 2014-050550, filed on Mar. 13, 2014; the entire contents of which are incorporated herein by reference.

### FIELD

The embodiment relates to an image processing apparatus and a solid-state imaging apparatus.

### BACKGROUND

A camera system which performs defect correction on a defective pixel (defect) detected from an image signal and the defect correction on a pixel of which address information is registered in advance is known. The defect correction performed based on defect judgment according to the image signal is referred to as dynamic defect correction. The defect correction performed according to the address information created in advance is referred to as mapping defect correction. Conventionally, the mapping defect correction is preferentially applied to a designated pixel designated by using the address information regardless of a result of the defect judgment according to the image signal. The dynamic defect correction is performed on a pixel other than the designated pixel of which the address information is registered.

Recently, there is the solid-state imaging apparatus equipped with a mode in which exposure time is set to be longer than that in normal imaging in order to compensate deterioration in optical detection sensitivity due to miniaturization of the pixels. In a case of the imaging with long time exposure, the solid-state imaging apparatus might generate a white defect caused by a dark current. The white defect is easily noticeable in a dark area of the image. In the dark area of the image, a remained white defect due to limited defect correction has a larger effect on image quality than possible deterioration in sense of resolution by adjustment as the defect correction. As illumination is lower and the exposure time is longer, the defect correction in which emphasis is put on reduction in the number of defects of the solid-state imaging apparatus is more desired. In the imaging with normal exposure time, the solid-state imaging apparatus is desired to be able to inhibit the deterioration in the sense of resolution.

### BRIEF DESCRIPTION OF THE DRAWINGS

FIG. 1 is a block diagram of a schematic configuration of a solid-state imaging apparatus according to a first embodiment;

FIG. 2 is a block diagram of a schematic configuration of a camera system including the solid-state imaging apparatus;

FIG. 3 is a block diagram of a configuration of a defect correcting circuit;

FIG. 4 is a view of an example of a pixel block;

FIG. 5 is a view illustrating positional information stored in a memory;

FIG. 6 is a view illustrating an interpolating process in a horizontal interpolating unit; and

FIGS. 7 and 8 are views illustrating an example of defect correction by the defect correcting circuit.

### DETAILED DESCRIPTION

In general, according to one embodiment, an image processing apparatus includes a defect correcting circuit. A solid-state imaging apparatus has the image processing apparatus. The defect correcting circuit performs defect correction on an image signal. The image signal is a signal from an imaging device in the solid-state imaging apparatus. The defect correcting circuit includes a defect judging unit, a first correcting unit, and a second correcting unit. The defect judging unit performs defect judgment on a target pixel based on pixel values of peripheral pixels. The target pixel is located on the center of a pixel block. In the pixel block, a plurality of pixels is arranged. The peripheral pixels are included in the pixel block. The defect judging unit uses a pixel value of a peripheral pixel in the defect judgment. The peripheral pixel is included in the pixel block. The first correcting unit performs replacement of a pixel value of the target pixel detected as a defect based on a result of the defect judgment. The second correcting unit performs an interpolating process of a pixel value on a designated pixel. The designated pixel is a pixel of which positional information is registered in advance as a defect. When the second correcting unit performs the interpolating process, the defect judging unit performs the defect judgment according to the pixel value subjected to the interpolating process.

Exemplary embodiments of an image processing apparatus and a solid-state imaging apparatus will be explained below in detail with reference to the accompanying drawings. The present invention is not limited to the following embodiments.

### Embodiment

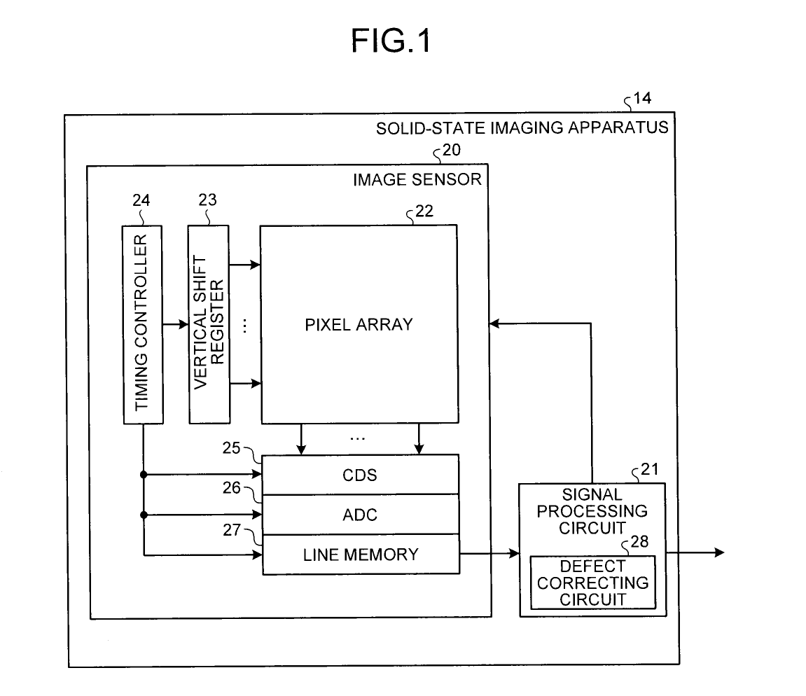

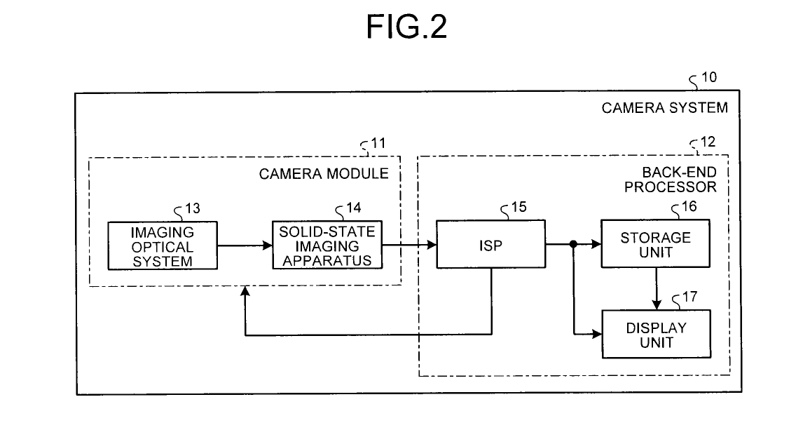

FIG. 1 is a block diagram of a schematic configuration of a solid-state imaging apparatus according to a first embodiment. FIG. 2 is a block diagram of a schematic configuration of a camera system including the solid-state imaging apparatus.

A camera system 10 being an electronic device including a camera module 11 is a portable terminal with built-in camera, for example. The camera system 10 may also be an electronic device other than the portable terminal with built-in camera such as a digital still camera and a digital video camera, for example.

The camera system 10 includes the camera module 11 and a back-end processor 12. The camera module 11 includes an imaging optical system 13 and a solid-state imaging apparatus 14. The back-end processor 12 includes an image signal processor (ISP) 15, a storage unit 16, and a display unit 17.

The imaging optical system 13 takes in light from a subject to form a subject image. The solid-state imaging apparatus 14 captures the subject image. The ISP 15 performs signal processing of an image signal obtained by imaging by the solid-state imaging apparatus 14. The storage unit 16 stores an image subjected to the signal processing by the ISP 15. The storage unit 16 outputs the image signal to the display unit 17 in response to operation of a user and the like.

The solid-state imaging apparatus 14 has an image sensor 20 being an imaging device and a signal processing circuit 21 being an image processing apparatus. The image sensor 20 captures the subject image. The image sensor 20 is a CMOS image sensor, for example. The image sensor 20 includes a pixel array 22, a vertical shift register 23, a timing controller 24, a correlated double sampling unit (CDS) 25, an analog-digital converter (ADC) 26, and a line memory 27.

The pixel array 22 is provided in an imaging area of the image sensor 20. In the pixel array 22, pixels are arranged in a horizontal direction (row direction) and a vertical direction (column direction) in an array. Each of the pixels includes a photodiode being a photoelectric conversion element. The photoelectric conversion element generates a signal charge corresponding to an incident light amount. Each pixel accumulates the signal charge according to the incident light amount. A Bayer array is used as an array of pixels of respective colors in the vertical direction and the horizontal direction in the pixel array 22.

The timing controller 24 controls reading of signals from a plurality of pixels. The timing controller 24 supplies a vertical synchronization signal which indicates a timing of reading of signals from the pixels in the pixel array 22 to the vertical shift register 23. The timing controller 24 supplies a timing signal which indicates drive timing to each of the CDS 25, the ADC 26, and the line memory 27.

The vertical shift register 23 selects each horizontal line of pixels in the pixel array 22 according to the vertical synchronization signal from the timing controller 24. The vertical shift register 23 outputs a read signal to each of the pixels in the selected horizontal line. The pixel to which the read signal is input from the vertical shift register 23 outputs the accumulated signal charge. The pixel array 22 outputs the signal from the pixels to the CDS 25 via vertical signal lines.

The CDS 25 performs a correlated double sampling process on the signal from the pixel array 22 for reducing fixed pattern noise. The ADC 26 converts the signals in an analog form into signals in a digital form. The line memory 27 accumulates the signal from the ADC 26. The image sensor 20 outputs the signal accumulated in the line memory 27.

The signal processing circuit 21 performs various types of signal processing on the image signal from the image sensor 20. The signal processing circuit 21 has a defect correcting circuit 28. The defect correcting circuit 28 performs defect correction. A defect is a deficient part of the digital image signal by the pixel which does not normally work. The defect includes a white defect and a black defect. The white defect is the defect indicating a signal level higher than that when the pixel normally works. The black defect is the defect indicating the signal level lower than that when the pixel normally works.

The signal processing circuit 21 performs various types of signal processing such as a gamma correction, a noise reducing process, a lens shading correction, a white balance adjustment, a distortion correction, and resolution restoration, for example, in addition to the defect correction. Configurations of the signal processing circuit 21 other than a configuration of the defect correcting circuit 28 are not illustrated in FIG. 1.

The solid-state imaging apparatus 14 outputs the image signal subjected to the signal processing by the signal processing circuit 21 out of a chip. The solid-state imaging apparatus 14 performs feedback control of the image sensor 20 based on data subjected to the signal processing by the signal processing circuit 21.

In the camera system 10, the ISP 15 of the back-end processor 12 may perform at least any of the various types of signal processing configured to be performed by the signal processing circuit 21 in this embodiment. In the camera system 10, both of the signal processing circuit 21 and the ISP 15 may perform at least any of the various types of signal processing. The signal processing circuit 21 and the ISP 15 may perform the signal processing other than the signal processing described in this embodiment.

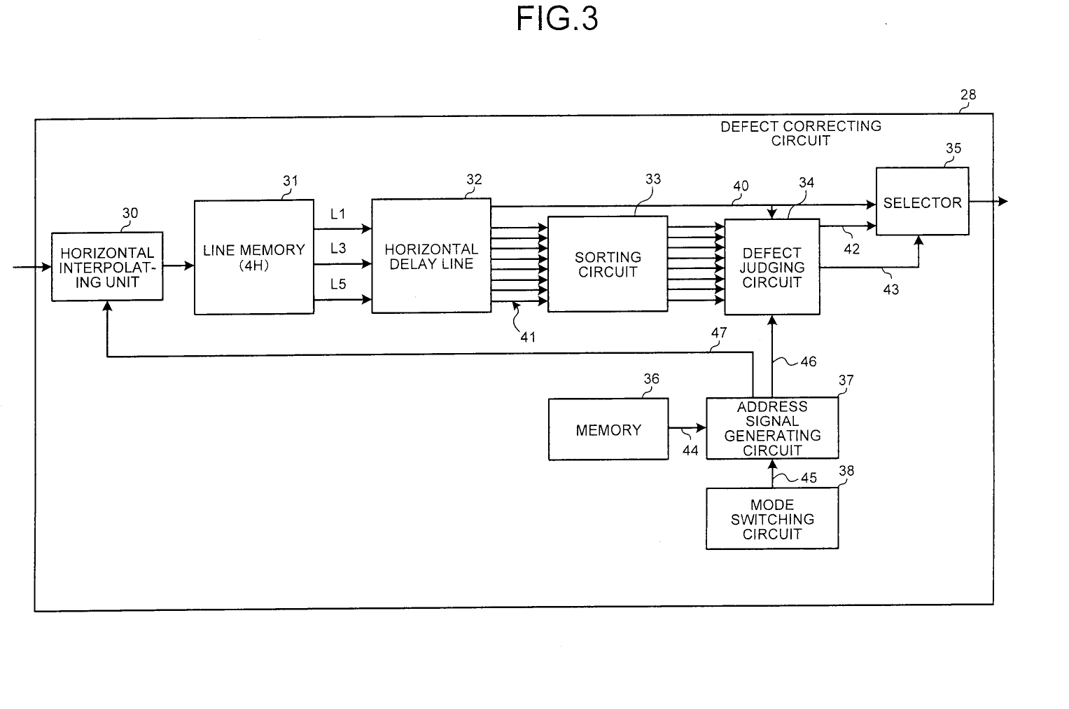

FIG. 3 is a block diagram of the configuration of the defect correcting circuit. The defect correcting circuit 28 performs dynamic defect correction and mapping defect correction. In the dynamic defect correction, the defect correcting circuit 28 detects the defect from the image signal during operation of the camera module 11. The defect correcting circuit 28 principally corrects the defect randomly generated depending on a temperature property of the photo diode, exposure time and the like as the dynamic defect correction.

The defect correcting circuit 28 stores positional information of the defect detected in defect inspection performed after manufacture of the camera module 11. The defect correcting circuit 28 principally corrects the defect steadily generated due to a structure of the photodiode such as a defect in a multi-layer structure and a leak current at a floating junction as the mapping defect correction.

The defect correcting circuit 28 includes a horizontal interpolating unit 30, a line memory 31, a horizontal delay line 32, a sorting circuit 33, a defect judging circuit 34, a selector 35, a memory 36, an address signal generating circuit 37, and a mode switching circuit 38.

The horizontal interpolating unit 30 performs an interpolating process as the mapping defect correction in a long exposure mode to be described later. The horizontal interpolating unit 30 performs the interpolating process in the horizontal direction on the image signal input to the defect correcting circuit 28.

The line memory 31 stores the signals of four lines (4H) and applies delay in the vertical direction (line delay). The line memory 31 outputs the signals of three lines (L1, L3, and L5) including a target pixel and peripheral pixels out of a total of five lines which are the stored four lines (L1, L2, L3, and L4) and a main line (L5) to the horizontal delay line 32.

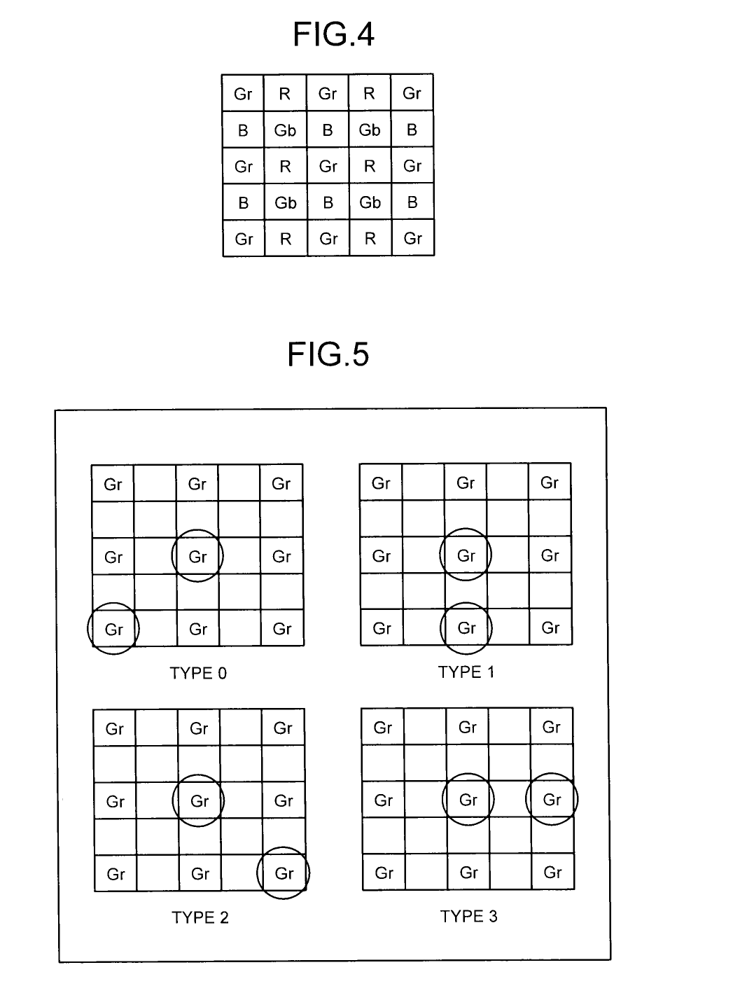

FIG. 4 is a view of an example of a pixel block. The defect correcting circuit 28 sets the pixel block centered on the target pixel the defect correction of which is performed. The pixel block is formed of 25 pixels arranged in a matrix pattern of five lines (L1 to L5) in the vertical direction and five pixels in the horizontal direction.

The Bayer arrangement in the pixel array 22 is configured in units of Gr, R, Gb, and B four pixels. The R pixel detects a red component. The B pixel detects a blue component. The Gr pixel is the pixel which detects a green component and is adjacent to the R pixel in the horizontal direction. The Gb pixel is the pixel which detects the green component and is adjacent to the B pixel in the horizontal direction. The image signals are input to the defect correcting circuit 28 as the signals of each line (Gr/R line and Gb/B line). An order of reading the signals forming the pixel block illustrated in FIG. 4 is from right to left in the horizontal direction and from top to bottom in the vertical direction.

In the pixel block illustrated in FIG. 4, the target pixel is the Gr pixel located on the center of the pixel block. The peripheral pixels are the pixels for the same color as the target pixel included in the pixel block. In the pixel block illustrated in FIG. 4, eight Gr pixels arranged with one pixel interposed between the same and the Gr pixel being the target pixel are the peripheral pixels. The defect correcting circuit 28 judges whether the target pixel is the defect by comparing a pixel value of the target pixel and the pixel value of the peripheral pixel. The defect correcting circuit 28 performs the signal processing by setting a kernel of three pixels in the vertical direction and three pixels in the horizontal direction (3×3) for the same color.

The horizontal delay line 32 holds the signals of four pixels for each line and applies delay in the horizontal direction. The horizontal delay line 32 synchronizes a signal 40 of the target pixel with signals 41 of the eight peripheral pixels. The horizontal delay line 32 outputs the signal 40 of the target pixel to the defect judging circuit 34 and the selector 35. The horizontal delay line 32 outputs the signals 41 of the peripheral pixels to the sorting circuit 33.

The sorting circuit 33 sorts the signals 41 of the eight peripheral pixels according to the signal level (pixel value). The sorting circuit 33 outputs the sorted eight signals 41 to the defect judging circuit 34.

The defect judging circuit 34 being a defect judging unit performs defect judgment of the target pixel. The defect judging circuit 34 determines that the target pixel is the white defect when the pixel value of the target pixel is larger than a maximum value of the pixel values of the peripheral pixels, for example. The defect judging circuit 34 determines that the target pixel is the black defect when the pixel value of the target pixel is smaller than a minimum value of the pixel values of the peripheral pixels, for example. The defect judging circuit 34 may perform the defect judgment of the target pixel by any method according to the pixel values of the peripheral pixels.

The defect judging circuit 34 calculates a correction value 42 for the defect correction according to the pixel value of the peripheral pixel. The defect judging circuit 34 calculates an average value of the pixel values ranked in predetermined places by the sorting circuit 33 out of the eight pixel values of the peripheral pixels, for example, as the correction value 42. The defect judging circuit 34 makes an average value of third to sixth pixel values from the top out of the eight pixel values of the peripheral pixels the correction value 42, for example. The defect judging circuit 34 may calculate the correction value 42 by any method which uses the pixel value of the peripheral pixel.

The defect judging circuit 34 generates a replacement signal 43 which issues an instruction to replace the pixel value when this determines that the target pixel is the defect. The defect judging circuit 34 outputs the correction value 42 and the replacement signal 43 to the selector 35.

The selector 35 being a first correcting unit performs replacement of the pixel value of the target pixel judged to be the defect. The selector 35 selects the correction value 42 when the replacement signal 43 is input. The selector 35 selects the pixel value of the target pixel when the replacement signal 43 is not input. The defect correcting circuit 28 outputs the pixel value selected by the selector 35.

The memory 36 being a storing unit is a non-volatile memory which stores positional information 44 of a designated pixel designated as the defect. The positional information 44 indicates a position of the defect detected in the defect inspection performed at the time of manufacture of the camera module 11.

The mode switching circuit 38 generates a mode switch signal 45. The camera module 11 shoots the subject image with switching a mode between a normal mode being a first mode and the long exposure mode being a second mode. The camera module 11 switches between the normal mode and the long exposure mode according to mode selection by the user, for example.

The image sensor 20 captures the subject image with adjusting exposure time in the normal mode and the long exposure mode. The normal mode is the mode selected at the time of the imaging with normal exposure time. The long exposure mode is the mode in which the exposure time is set to be longer than that in the normal mode. The mode switching circuit 38 outputs the mode switch signal 45 in response to the instruction to switch the mode between the normal mode and the long exposure mode.

The address signal generating circuit 37 being an address signal generating unit recognizes which of the normal mode and the long exposure mode the current mode is according to the mode switch signal 45. In the normal mode, the address signal generating circuit 37 reads the positional information 44 from the memory 36 to generate an address signal 46. The address signal generating circuit 37 recognizes an address of the target pixel the signal 40 of which is input to the defect judging circuit 34. The address signal generating circuit 37 determines whether the address of such target pixel is the same as the address included in the positional information 44. When both addresses are the same, the address signal generating circuit 37 outputs the address signal 46 to the defect judging circuit 34. The address signal 46 is a pulse for identifying the target pixel the signal 40 of which is input to the defect judging circuit 34 as the designated pixel registered as the defect.

In the long exposure mode, the address signal generating circuit 37 reads the positional information 44 from the memory 36 to generate the address signal 47. The address signal generating circuit 37 recognizes the address of the pixel the signal of which is input to the horizontal interpolating unit 30. The address signal generating circuit 37 determines whether the address of such pixel is the same as the address included in the positional information 44. When both addresses are the same, the address signal generating circuit 37 outputs the address signal 47 to the horizontal interpolating unit 30. The address signal 47 is a pulse for identifying the pixel the signal of which is input to the horizontal interpolating unit 30 as the designated pixel registered as the defect.

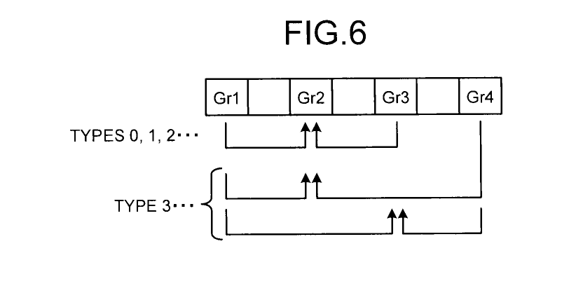

FIG. 5 is a view illustrating the positional information stored in the memory. In the camera module 11, the information indicating the positions of the defects is registered as the positional information 44 for each case in which two or more defects are included in same color pixels in the pixel block.

The cases in which the two defects are included in the same color pixels in the pixel block are classified into four types illustrated in FIG. 5. Each of the four types represents positional relationship between the two defects such that one of the two defects the signal of which is read first into the defect correcting circuit 28 is located on the center of the pixel block. In each type, one of the defects is located on the center of the pixel block and the other defect is any of the same color pixels the signal of which is read thereafter. Herein, a case in which the Gr pixel is the defect is described as an example. Hereinafter, the description of the case in which the Gr pixel is the defect is also applicable to each of cases in which one of the R pixel, the B pixel, and the Gb pixel is the defect.

In a type 0, one defect is located on the center of the pixel block and the other defect is located below to the left of the same. In a type 1, one defect is located on the center of the pixel block and the other defect is located below the same. In a type 2, one defect is located on the center of the pixel block and the other defect is located below to the right of the same. In a type 3, one defect is located on the center of the pixel block and the other defect is located to the right of the same.

The positions of the two defects in each type may be represented by using the address of the defect located on the center of the pixel block and the type. The memory 36 stores data in which the address of the defect located on the center of the pixel block and the type are combined as the positional information 44 for each case in which the two defects are included in the same color pixels in the pixel block. The address signal generating circuit 37 grasps the addresses of the two defects in each case based on the positional information 44.

For example, when the normal mode is selected, the address signal generating circuit 37 outputs the address signal 46 to the defect judging circuit 34 in response to the fact that the address of the target pixel is the same as the address included in the positional information 44. The address signal generating circuit 37 does not output the address signal 47 to the horizontal interpolating unit 30. The defect correcting circuit 28 stops the interpolating process performed by the horizontal interpolating unit 30 on the image signal obtained by the imaging in the normal mode by the image sensor 20.

When the address signal 46 is input to the defect judging circuit 34, this outputs the replacement signal 43 regardless of a result of the defect judgment. The defect judging circuit 34 calculates the correction value 42 for the mapping defect correction by using the pixel value of the peripheral pixel. The defect judging circuit 34 calculates the average value of the pixel values ranked in predetermined places by the sorting circuit 33 out of the eight pixel values of the peripheral pixels as the correction value 42, for example. The defect judging circuit 34 makes the average value of the third to sixth pixel values from the top out of the eight pixel values of the peripheral pixels the correction value 42, for example.

The top two pixel values out of the eight pixel values of the peripheral pixels might result from the white defects included in the peripheral pixels. The bottom two pixel values might result from the black defects included in the peripheral pixels. The defect correcting circuit 28 may perform the defect correction eliminating an effect of the defects by eliminating the top two pixel values and the bottom two pixel values to calculate the correction value 42. Meanwhile, the defect judging circuit 34 may also calculate the correction value 42 by any method which uses the pixel value of the peripheral pixel.

The selector 35 selects the correction value 42 in response to the input of the replacement signal 43. According to this, the defect correcting circuit 28 performs the mapping defect correction in the normal mode on the target pixel. In the normal mode, the selector 35 performs the replacement of the pixel value of the target pixel being the designated pixel.

The defect correcting circuit 28 corrects the defect located on the center of the pixel block out of the two defects included in the pixel block as the target pixel by the mapping defect correction. For the other defect also, the defect correcting circuit 28 performs the mapping defect correction of the defect as the target pixel when the defect is located on the center of the pixel block.

For example, when the long exposure mode is selected, the address signal generating circuit 37 outputs the address signal 47 to the horizontal interpolating unit 30 in response to the fact that the address of the pixel input to the horizontal interpolating unit 30 is the same as the address included in the positional information 44. The defect correcting circuit 28 allows the horizontal interpolating unit 30 to perform the interpolating process on the image signal obtained by the imaging in the long exposure mode by the image sensor 20.

The address signal generating circuit 37 does not output the address signal 46 to the defect judging circuit 34. The defect correcting circuit 28 stops the mapping defect correction performed by the defect judging circuit 34 and the selector 35.

In the long exposure mode, the horizontal Interpolating unit 30 being a second correcting unit performs the interpolating process which uses the pixel value of the same color pixel in a position in the horizontal direction from the designated pixel on the designated pixel the positional information 44 of which is registered in advance as the defect.

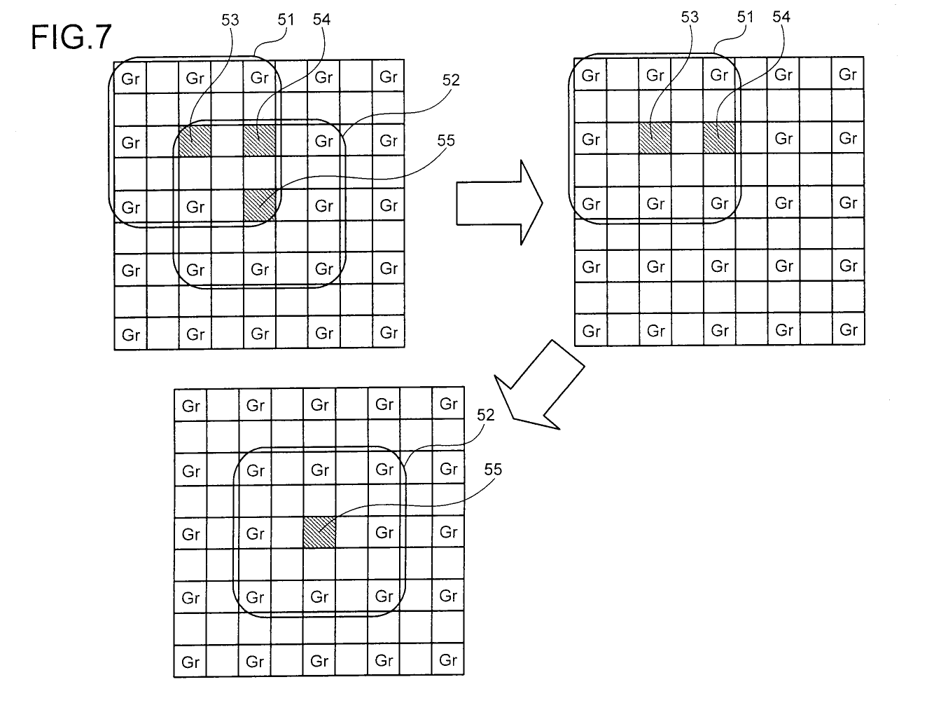

FIG. 6 is a view illustrating the interpolating process in the horizontal interpolating unit. The horizontal interpolating unit 30 performs the interpolating process on each designated pixel the positional information 44 of which is registered as the defect.

The horizontal interpolating unit 30 has a horizontal delay line (not illustrated) which stores signals of pixels Gr1, Gr2, and Gr3 being three same color pixels, for example. The horizontal interpolating unit 30 synchronizes the signals of the pixels Gr1, Gr2, and Gr3 and a signal of the pixel Gr4 being the same color pixel input to the horizontal interpolating unit 30.

The horizontal interpolating unit 30 performs the similar interpolating process on the two defects in the above-described positional relationship of the type 0, for example. For example, suppose that the pixel Gr2 is the designated pixel being the defect. The horizontal interpolating unit 30 calculates an average value ((Gr1+Gr3)/2) of the pixel values of the two pixels Gr1 and Gr3 adjacent to the pixel Gr2 in the horizontal direction.

The horizontal interpolating unit 30 calculates such average value for each of the two defects included in the pixel block. The horizontal interpolating unit 30 replaces with the calculated average value for the two designated pixels designated as the defects. According to this, the horizontal interpolating unit 30 performs the horizontal interpolation on each designated pixel.

Regarding the two defects in the above-described positional relationship of the type 1 and the two defects in the positional relationship of the type 2 also, the horizontal interpolating unit 30 performs the horizontal interpolation on each designated pixel as in the case of the type 0.

In the above-described type 3, the two defects are arranged in the horizontal direction. The horizontal interpolating unit 30 performs the interpolating process including weighting according to a distance from the designated pixel on the designated pixels of which the positional information 44 indicating the positional relationship of the type 3 is registered. For example, suppose that the pixels Gr2 and Gr3 are the designated pixels being the defects.

The horizontal interpolating unit 30 uses the pixel value of the pixel Gr1 located to the left of the pixel Gr2 and the pixel value of the pixel Gr4 located to the right of the pixel Gr3 in the interpolating process of the pixel Gr2 located on a left side out of the two defects. The horizontal interpolating unit 30 calculates an average value (Gr1×2/3+Gr4×1/3) of the pixel value of the pixel Gr1 and the pixel value of the pixel Gr4. Such average value includes the weighting according to the distance from the pixel Gr2 being the defect. The weighting is set such that a ratio increases as the pixel the pixel value of which is used is closer to the defect.

The horizontal interpolating unit 30 uses the pixel value of the pixel Gr1 located to the left of the pixel Gr2 and the pixel value of the pixel Gr4 located to the right of the pixel Gr3 in the interpolating process of the pixel Gr3 located on a right side out of the two defects. The horizontal interpolating unit 30 calculates an average value (Gr1×1/3+Gr4×2/3) of the pixel value of the pixel Gr1 and the pixel value of the pixel Gr4. Such average value includes the weighting according to the distance from the pixel Gr3 being the defect.

According to this, the defect correcting circuit 28 performs the mapping defect correction in the long exposure mode on the designated pixel. Meanwhile, the horizontal interpolating unit 30 may omit the interpolating process of the other defect while performing the interpolating process on the defect located on the center of the pixel block out of the two defects included in the pixel block. The defect correcting circuit 28 corrects the defect the interpolating process of which is omitted by the dynamic defect correction in which the defect is made the target pixel after the mapping defect correction.

The horizontal interpolating unit 30 outputs the signal subjected to the mapping defect correction of the designated pixel to the line memory 31. Meanwhile, in the normal mode, and for the pixel other than the designated pixel in the long exposure mode, the horizontal interpolating unit 30 does not perform the interpolating process on the input signal and outputs the input signal to the line memory 31.

In the long exposure mode, the defect correcting circuit 28 performs the process for the direct defect correction on the signal subjected to the mapping defect correction of the designated pixel is performed as in the normal mode. When the horizontal interpolating unit 30 performs the interpolating process, the defect judging circuit 34 performs the defect judgment which uses the pixel value subjected to the interpolating process.

In the long exposure mode also, the defect judging circuit 34 calculates the average value of the third to sixth pixel values from the top out of the eight pixel values of the peripheral pixels, for example, and makes the calculated average value the correction value 42. The defect correcting circuit 28 may perform the defect correction without the effect of the defect by calculating the correction value 42 eliminating the top two pixel values and the bottom two pixel values.

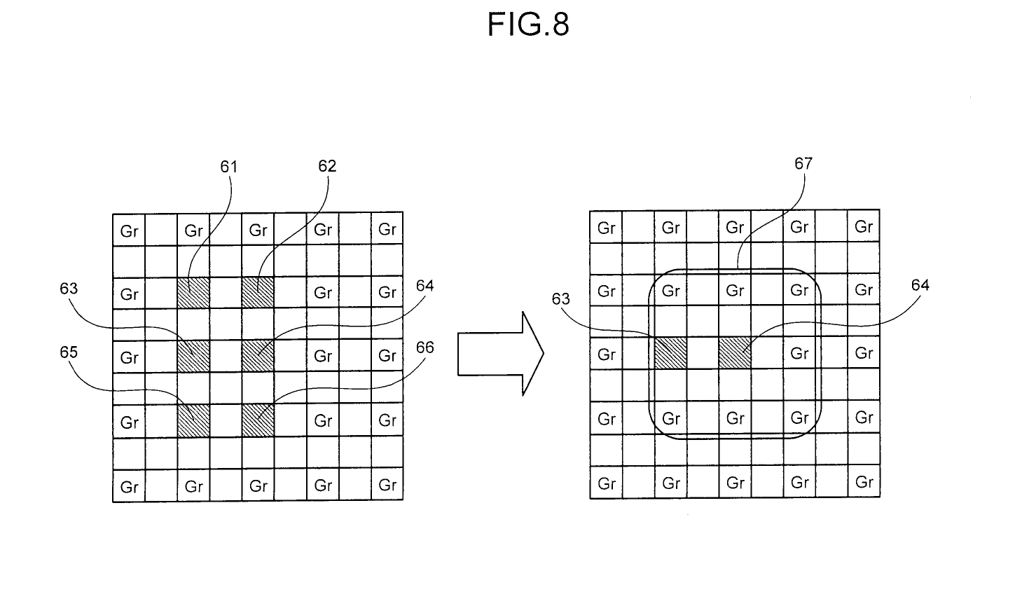

FIGS. 7 and 8 are views illustrating an example of the defect correction by the defect correcting circuit. In the example illustrated in FIG. 7, suppose that three Gr pixels 53, 54, and 55 are the white defects detected in the defect inspection. The Gr pixel 54 is located to the right of the Gr pixel 53. The Gr pixel 55 is located below the Gr pixel 54.

A kernel 51 delimiting the pixel block centered on the Gr pixel 53 includes three white defects. A kernel 52 delimiting the pixel block centered on the Gr pixel 55 includes three white defects.

In a case in which the positional information 44 about up to two defects in the kernels 51 and 52 is registered, one defect remains uncorrected in a case in which the three defects are included in the kernels 51 and 52 by the conventional mapping defect correction. The solid-state imaging apparatus 14 easily generates the white defect due to a dark current in the long exposure mode and the white defect remaining in a dark area of the image deteriorates image quality.

It is required to increase a capacity of the memory 36 by an increase in stored data amount for the defect correcting circuit 28 to register the positional information about three or more defects in the kernels 51 and 52.

In this embodiment, the positional information 44 about any two of the three defects included in the kernels 51 and 52 is registered in advance in the defect correcting circuit 28. In the long exposure mode, the defect correcting circuit 28 performs the mapping defect correction by the interpolating process by the horizontal interpolating unit 30 on the two defects the positional information 44 of which is registered. The defect correcting circuit 28 performs the dynamic defect correction by the defect judging circuit 34 and the selector 35 on remaining one defect.

For example, for the three Gr pixels 53, 54, and 55 being the white defects, the positional information 44 is registered about the Gr pixel 53 located on the center of one kernel 51 and one Gr pixel 54 out of the Gr pixels 54 and 55 other than this in the defect correcting circuit 28. The defect correcting circuit 28 registers the positional information 44 of the Gr pixels 53 and 54 considering that the kernel 51 is of the above-described type 3.

The horizontal interpolating unit 30 performs the interpolating process on the two white defects the positional information 44 of which is registered for the kernel 51. The defect correcting circuit 28 corrects two of the three white defects by such mapping defect correction.

The defect judging circuit 34 performs the defect judgment on the Gr pixel 55 as the target pixel for the kernel 52 centered on the Gr pixel 55 being the remaining one white defect. The Gr pixel 55 is determined to be the white defect by the defect judging circuit 34, so that the selector 35 performs replacement of the pixel value of the Gr pixel 55. The defect correcting circuit 28 corrects the remaining one of the three white defects by such dynamic defect correction. According to this, the defect correcting circuit 28 may realize the correction of the three defects by performing the mapping defect correction which uses the positional information 44 registered about the two defects and further performing the dynamic defect correction even when the three defects are included in the pixel block.

In the example illustrated in FIG. 7, the defect correcting circuit 28 may appropriately change the method of the defect correction for the three white defects. The defect correcting circuit 28 may perform the mapping defect correction on the Gr pixels 53 and 55 and the dynamic defect correction on the Gr pixel 54 considering that the kernel 51 is of the above-described type 2.

Next, in the example illustrated in FIG. 8, suppose that six Gr pixels 61, 62, 63, 64, 65, and 66 are the white defects detected in the defect inspection. The six white defects are included in the kernel delimiting the pixel block centered on the Gr pixel 63.

The defect correcting circuit 28 may register the positional information 44 considering that each of a group of the Gr pixels 61 and 62, a group of the Gr pixels 63 and 64, and a group of the Gr pixels 65 and 66 is of the above-described type 3. The horizontal interpolating unit 30 performs the interpolating process on the two white defects in each group. The defect correcting circuit 28 corrects the six white defects by such mapping defect correction.

The defect correcting circuit 28 may register the positional information 44 considering that two of the group of the Gr pixels 61 and 62, the group of the Gr pixels 63 and 64, and the group of the Gr pixels 65 and 66 are of the above-described type 3. When the positional information 44 is registered about the group of the Gr pixels 61 and 62 and the group of the Gr pixels 65 and 66, the defect correcting circuit 28 corrects four white defects of the Gr pixels 61, 62, 65, and 66 by the mapping defect correction according to the positional information 44.

The defect correcting circuit 28 corrects the white defect of the Gr pixel 64 being the target pixel by the dynamic defect correction for a kernel 67 centered on the Gr pixel 64 as a target for the Gr pixel 64 out of remaining two white defects. The defect correcting circuit 28 also corrects the white defect of the Gr pixel 63 by the dynamic defect correction as in a case of the Gr pixel 64. According to this, the defect correcting circuit 28 may correct the six white defects with reduced stored data as compared to a case in which the positional information 44 of all the six white defects is registered.

According to the embodiment, the solid-state imaging apparatus 14 performs the dynamic defect correction after the mapping defect correction on the designated pixel the positional information 44 of which is registered in the long exposure mode. The solid-state imaging apparatus 14 may realize the defect correction with emphasis on reduction in the number of defects by further performing the defect correction according to the defect judgment when performing the defect correction according to the positional information 44. The solid-state imaging apparatus 14 effectively reduces the white defects having a large effect on the image quality, thereby obtaining a high-quality image in the imaging in which illumination is low and exposure time is long.

The solid-state imaging apparatus 14 preferentially performs the mapping defect correction on the designated pixel the positional information 44 of which is registered in the normal mode regardless of the result of the defect judgment. When the pixel other than the designated pixel is the target pixel and it is determined that the target pixel is the defect, the solid-state imaging apparatus 14 performs the dynamic defect correction. The solid-state imaging apparatus 14 performs the defect correction in which more emphasis is put on sense of resolution than on the reduction in the number of defects in the imaging with the normal exposure time. The solid-state imaging apparatus 14 may effectively inhibit deterioration in the sense of resolution, thereby obtaining the high-quality image in the imaging with the normal exposure time.

According to this, the solid-state imaging apparatus 14 has an effect of obtaining the high-quality image by appropriate defect correction in both of the cases in which the exposure time is made longer and in which the normal exposure time.

In the defect correcting circuit 28, the horizontal interpolating unit 30 for the interpolating process and a path through which the address signal 47 is input to the horizontal interpolating unit 30 are added to the configuration for the defect correction including the defect judging circuit 34 and the selector 35. It is only necessary that the horizontal interpolating unit 30 is provided with a small-scale signal delay line as a configuration for signal delay. Since the horizontal interpolating unit 30 is added, an extended circuit scale of the defect correcting circuit 28 may be made small as compared to a case in which the line memory for the interpolating process in the vertical direction should be added. Therefore, the solid-state imaging apparatus 14 may inhibit increase in circuit scale by addition of the interpolating process by applying the horizontal interpolating unit 30 to the defect correcting circuit 28.

For example, suppose that presence of the pixel block including the three or more defects is confirmed in the inspection detection of the camera module 11 while the number of defects the positional information 44 of which may be registered in advance is set to two for each kernel. The camera module 11 may realize the defect correction by registering the positional information 44 by appropriately selecting two of the defects. According to this embodiment, such camera module 11 is not immediately treated as a defective product but might be treated as a non-defective product. The camera module 11 may improve a yield with an eased standard being a passing criterion of the defect inspection.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus in a solid-state imaging apparatus, the image processing apparatus configured to comprise:
a defect correcting circuit which performs defect correction on an image signal from an imaging device in the solid-state imaging apparatus, wherein
the defect correcting circuit includes
a defect judging unit which performs defect judgment on a target pixel based on pixel values of peripheral pixels;
a first correcting unit which performs replacement of a pixel value of the target pixel detected as a defect based on a result of the defect judgment; and
a second correcting unit which performs an interpolating process of a pixel value on a designated pixel of which positional information is registered in advance as a defect, wherein
the target pixel is located on the center of a pixel block in which a plurality of pixels are arranged,
the peripheral pixels are included in the pixel block, and
when the second correcting unit performs the interpolating process, the defect judging unit performs the defect judgment according to the pixel value subjected to the interpolating process.

2. The image processing apparatus according to claim 1, wherein
the second correcting unit performs the interpolating process according to a pixel value of a pixel in a position in a horizontal direction from the designated pixel.

3. The image processing apparatus according to claim 1, wherein
the second correcting unit stops the interpolating process when the image signal is obtained by imaging in a first mode, and
the second correcting unit performs the interpolating process when the image signal is obtained by imaging in a second mode in which exposure time longer than the exposure time in the first mode is set.

4. The image processing apparatus according to claim 3, wherein
the first correcting unit performs replacement of the pixel value of the designated pixel in the first mode.

5. The image processing apparatus according to claim 4, wherein
the defect correcting circuit includes an address signal generating unit which generates an address signal for identifying the designated pixel according to the positional information,
the address signal generating unit outputs the address signal to the defect judging unit in the first mode, and
the address signal generating unit outputs the address signal to the second correcting unit in the second mode.

6. The image processing apparatus according to claim 1, wherein
the defect correcting circuit includes a storing unit which stores the positional information registered in advance, and
the storing unit stores the positional information of two designated pixels included in the pixel block.

7. The image processing apparatus according to claim 2, wherein
the second correcting unit performs the interpolating process including weighting according to a distance from the designated pixel when the positional information of two designated pixels arranged in the horizontal direction is registered.

8. A solid-state imaging apparatus comprising:
an imaging device which captures a subject image; and
a defect correcting circuit which performs defect correction on an image signal from the imaging device, wherein
the defect correcting circuit includes
a defect judging unit which performs defect judgment on a target pixel based on pixel values of peripheral pixels;
a first correcting unit which performs replacement of a pixel value of the target pixel detected as a defect based on a result of the defect judgment; and
a second correcting unit which performs an interpolating process of a pixel value on a designated pixel of which positional information is registered in advance as a defect, wherein
the target pixel is located on the center of a pixel block in which a plurality of pixels are arranged,
the peripheral pixels are included in the pixel block, and
when the second correcting unit performs the interpolating process, the defect judging unit performs the defect judgment according to the pixel value subjected to the interpolating process.

9. The solid-state imaging apparatus according to claim 8, wherein
the second correcting unit performs the interpolating process according to a pixel value of a pixel in a position in a horizontal direction from the designated pixel.

10. The solid-state imaging apparatus according to claim 8, wherein
the imaging device captures the subject image in a first mode and in a second mode in which exposure time longer than the exposure time in the first mode is set,
the second correcting unit stops the interpolating process in the first mode, and
the second correcting unit performs the interpolating process in the second mode.

11. The solid-state imaging apparatus according to claim 10, wherein
the first correcting unit performs replacement of the pixel value of the designated pixel in the first mode.

12. The solid-state imaging apparatus according to claim 11, wherein
the defect correcting circuit includes an address signal generating unit which generates an address signal for identifying the designated pixel according to the positional information,
the address signal generating unit outputs the address signal to the defect judging unit in the first mode, and
the address signal generating unit outputs the address signal to the second correcting unit in the second mode.

13. The solid-state imaging apparatus according to claim 8, wherein
the defect correcting circuit includes a storing unit which stores the positional information registered in advance, and
the storing unit stores the positional information of two designated pixels included in the pixel block.

14. The solid-state imaging apparatus according to claim 9, wherein
the second correcting unit performs the interpolating process including weighting according to a distance from the designated pixel when the positional information about two designated pixels arranged in the horizontal direction is registered.

15. An image processing apparatus in a solid-state imaging apparatus, the image processing apparatus configured to comprise:
a defect correcting circuit which performs defect correction on an image signal from an imaging device in the solid-state imaging apparatus, wherein
the defect correcting circuit includes
a defect judging unit which performs defect judgment on a target pixel based on pixel values of peripheral pixels;
a first correcting unit which performs replacement of the pixel value of the target pixel detected as a defect based on a result of the defect judgment; and
a second correcting unit which performs an interpolating process of the pixel value on a designated pixel positional information of which is registered in advance as a defect, wherein
the target pixel is located on the center of a pixel block in which a plurality of pixels are arranged,
the peripheral pixels are included in the pixel block, and
the second correcting unit performs the interpolating process according to the pixel value of a pixel in a position in a horizontal direction from the designated pixel.

16. The image processing apparatus according to claim 15, wherein
the second correcting unit performs the interpolating process including weighting according to a distance from the designated pixel when the positional information of two designated pixels arranged in the horizontal direction is registered.

17. The image processing apparatus according to claim 15, wherein
the second correcting unit stops the interpolating process when the image signal is obtained by imaging in a first mode, and
the second correcting unit performs the interpolating process when the image signal is obtained by imaging in a second mode in which exposure time longer than the exposure time in the first mode is set.

18. The image processing apparatus according to claim 17, wherein
the first correcting unit performs replacement of the pixel value of the designated pixel in the first mode.

19. The image processing apparatus according to claim 18, wherein
the defect correcting circuit includes an address signal generating unit which generates an address signal for identifying the designated pixel according to the positional information,
the address signal generating unit outputs the address signal to the defect judging unit in the first mode, and
the address signal generating unit outputs the address signal to the second correcting unit in the second mode.

20. The image processing apparatus according to claim 15, wherein
the defect correcting circuit includes a storing unit which stores the positional information registered in advance, and
the storing unit stores the positional information of two designated pixels included in the pixel block.
